(19) United States
(12) Patent Application Publication
(10) Pub. No.: US 2008/0112391 A1
(43) Pub. Date: May 15, 2008

(54) Method for enabling an autodial via Internet

(75) Inventors: Shaw Hwa Hwang, Taipei (TW); Yu Wei Jhang, Taipei (TW); Yao Hsing Chung, Taipei (TW); Chen Hung Wu, Taipei (TW); Chen Yi Wu, Taipei (TW); Kuan Lin Chen, Taipei (TW); Kuo Wei Liu, Taipei (TW); Cheng Yu Yeh, Taipei (TW)

Correspondence Address: BACON & THOMAS, PLLC, 625 SLATERS LANE, FOURTH FLOOR, ALEXANDRIA, VA, 22314, US

(73) Assignee: Color City Enterprise Co., Ltd., Apia (WS)

(21) Appl. No.: 11/524,923

(22) Filed: Sep. 22, 2006

(30) Foreign Application Priority Data
Jul. 3, 2006 (TW) 095124179

(51) Int. Cl. H04L 12/66

(52) U.S. Cl. 370/352

(57) ABSTRACT

A method for enabling an autodial via Internet comprises the steps of: designing a VoIP related software; packaging the VoIP related software into an Active-X element; buying CodeSign from Microsoft for being added into the Active-X element for a digital signature, and acquiring a certified ID from Microsoft; and installing the Active-X element in a webpage. After the webpage is sent to a user's computer display via the Internet, the Active-X element will appear as an icon at a specific position in the webpage for enabling the user to click, after clicking the Active-X element with the mouse, the VoIP related software will be installed in the user's computer and will automatically guide the user to a specific telephone number.

### FIELD OF THE INVENTION

The present invention relates to a method for enabling an Internet phone call, and more particularly to a service method for enabling an autodial via the Internet without pre-installing.

### BACKGROUND OF THE INVENTION

Calling via the Internet is much cheaper than the conventional method, that's why it is widely spread. Internet phone calls generally include three types, and all have to use VoIP (Voice over Internet Protocol) to write relative software. The three types of Internet phone call are explained below:

1. Conventional type: the user can buy a CD containing the VOIP related software, and installs the VoIP related software in a computer equipped with microphone and earphone/speaker, and then the user can make a call by keying a telephone number.

2. Auto-booting type: the user can buy a flash disk containing VoIP related software, and inserts it into a USB port of a computer equipped with microphone and earphone/speaker, and then the user can make a call by keying a telephone number through the keyboard. After the flash disk is taken off from the computer, there is no VoIP related software in the computer.

3. Skype type: the user can download Skype software (which is also a VoIP related software) from the Internet, when installing Skype, the user must enter necessary information, such as account number, password, etc. After that, the user is allowed to make a call by entering account number and password.

However, the three aforementioned types of Internet calls all require complicated installation procedures, and even require the user to apply for the telephone numbers. The user has to dial the telephone number and has to pay the telephone charge by himself.

Nowadays, many companies utilize webpages and Internet to sell their products. When their webpages are connected to the screen of a user's computer via Internet, the charge for calling the telephone number displayed on the webpages may be paid by the company (receiver), however, the user still has to dial the phone number by himself.

The present invention has arisen to mitigate and/or obviate the afore-described disadvantages.

### SUMMARY OF THE INVENTION

The primary objective of the present invention is to provide a method for enabling an autodial via Internet without requiring complicated installation procedures, and without requiring the user to memorize the telephone number to be dialed.

A method for enabling an autodial via Internet comprises the steps of:
a. designing a VoIP related software;
b. packaging the VoIP related software into an Active-X element;
c. buying CodeSign from Microsoft for being added into the Active-X element for digital signature, and acquiring a certified ID from Microsoft;
d. installing the Active-X element in a related webpage.

After the webpage is sent to the user computer's display via the Internet, the Active-X will appear as a icon at a specific position in the webpage for enabling the user to click, after clicking the Active-X with the mouse, the VoIP related software will be installed in the user's computer and will automatically guide the user to a specific telephone number.

### BRIEF DESCRIPTION OF THE DRAWINGS

FIG. 1 is a flow chart of showing the steps of a method for enabling an autodial via the Internet; and

FIG. 2 shows that the Active-X appears at a specific position in a related webpage.

### DETAILED DESCRIPTION OF THE PREFERRED EMBODIMENTS

The present invention will become clearer from the following description when viewed together with the accompanying drawings, which show, for purpose of illustrations only, the preferred embodiment in accordance with the present invention.

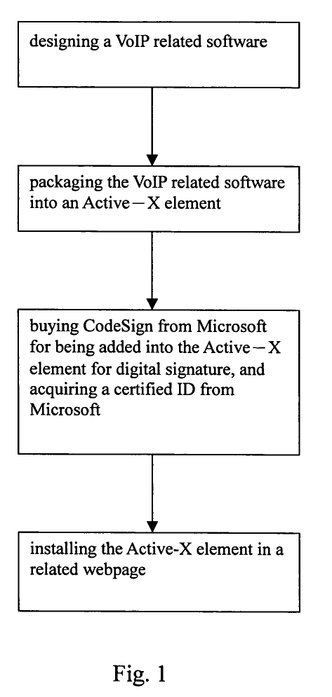

Referring to FIG. 1, which is a flow chart of showing the steps of a method for enabling an auto-dialing via network, and the method comprises the steps of:]
1. designing a VoIP related software;
2. packaging the VoIP related software into an Active-X element, the Active-X element software is used as an autodialing route for an Internet phone call, and a icon of the Active-X element will appear on the display of the computer and is to be clicked by the user through a mouse. The Active-X element will be activated after clicking with the mouse by the user, and then the Active-X element will install VoIP related software in the user's computer and guide the user to a specific telephone number (which is preset in the VoIP related software, usually a company's main phone number or service number);
3. buying CodeSign from Microsoft for being added into the Active-X element for digital signature, and acquiring a certified ID from Microsoft, thus ensuring that the user's computer will not be damaged by a hacker when the user downloads VoIP related software from Internet;
4. installing the Active-X element in a company's webpage.

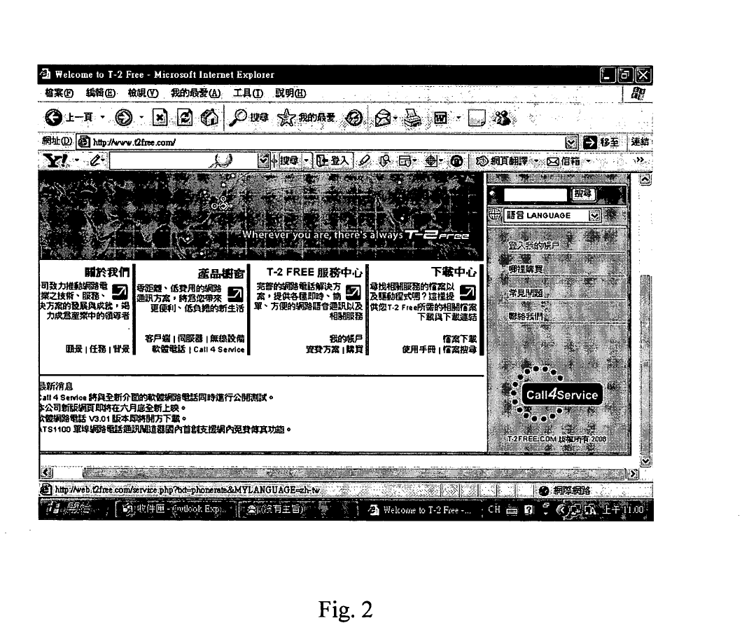

When a company is going to use webpage and Internet to sell products, it can pay to obtain the abovementioned services, and to design the abovementioned software in the company's server. And then the company's server is connected to the Internet for enabling the users to download the webpage. When the webpage is sent to the user computer's display via the Internet, the Active-X element will appear as an icon at a specific position in the webpage (the “Call 4 service” shown in the bottom-right corner of FIG. 2) for enabling the user to click. After clicking the icon of the Active-X element by the user with the mouse, the VoIP related software will be installed in the user's computer and will automatically guide the user to a specific telephone number (which is preset in the VoIP related software, usually a company's main phone number or service number), so that the user can make a call via the Internet to ask for relative services or answers. The user doesn't need to pay any telephone charge, the company has paid to obtain the abovementioned services. Therefore, this is an Internet autodial “collect call” (paid by the receiver (company)). The user doesn't need to dial the telephone number and only needs to click the specific icon of the Active-X element in the company's webpage with the mouse.

The present invention can replace the conventional method of collect call of number “0800”, enabling the user to use the autodial Internet phone call conveniently without dialing a number, and can improve the company's marketing efficiency. The GOOGLE website can also adopt the service method of the present invention to improve their services

In addition to the voice processing software, the VoIP related software of the present invention also can include image processing software for enabling the users to talk face to face.

While we have shown and described various embodiments in accordance with the present invention, it is clear to those skilled in the art that further embodiments may be made without departing from the scope of the present invention.

What is claimed is:

1. A method for enabling an autodial via Internet, comprising the steps of:
a. designing a VoIP related software;
b. packaging the VoIP related software into an Active-X element;
c. buying CodeSign from Microsoft for being added into the Active-X element for a digital signature, and acquiring a certified ID from Microsoft;
d. installing the Active-X element in a related webpage.

2. The method for enabling an autodial via Internet as claimed in claim 1, wherein after the webpage is sent to a user's computer display via the Internet, the Active-X element will appear as an icon at a specific position in the webpage for enabling the user to click, after clicking the Active-X with the mouse, the VoIP related software will be installed in the user's computer and will automatically guide the user to a specific telephone number.

3. The method for enabling an autodial via Internet as claimed in claim 1, wherein the VoIP related software includes image processing software for enabling users to talk face to face.

4. The method for enabling an autodial via Internet as claimed in claim 2, wherein the VoIP related software includes image processing software for enabling users to talk face to face.
